(19) United States
(12) Patent Application Publication
(10) Pub. No.: US 2017/0216151 A1
(43) Pub. Date: Aug. 3, 2017

(54) FREEZABLE SPOUTED PACKAGE

(71) Applicant: NESTEC S.A., Vevey (CH)

(72) Inventors: Joel Dean GENAW, JR., Hesperia, MI (US); Matthew Blake RODGERS, Grand Haven, MI (US); Barbara Burzinski HARTLIEP, Spring Lake, MI (US); Scott David PETERSON, Spring Lake, MI (US)

(21) Appl. No.: 15/421,757

(22) Filed: Feb. 1, 2017

Related U.S. Application Data
(60) Provisional application No. 62/289,523, filed on Feb. 1, 2016.

(51) Int. Cl. A61J 9/00; B65D 47/12; B65D 85/72; B65D 35/24; B65D 75/58

(52) U.S. Cl. CPC A61J 9/005; B65D 35/24; B65D 75/5883; B65D 85/72; B65D 47/122; B65D 75/5827

(57) ABSTRACT

A package for consuming a food product in a frozen or non-frozen state. The package includes a pouch body and a fitment. The pouch body defines a chamber for receiving the food product and includes a cut of predetermined depth to facilitate tearing of the pouch body to create an opening for dispensing the food product in a frozen state. The fitment includes a spout for dispensing the food product in a non-frozen state.

### CROSS REFERENCE TO RELATED APPLICATIONS/INCORPORATION BY REFERENCE STATEMENT

The subject application claims benefit under 35 USC §119(e) of provisional application U.S. Ser. No. 62/289,523, filed Feb. 1, 2016; the entire contents of which are expressly incorporated herein by reference.

### STATEMENT REGARDING FEDERALLY SPONSORED RESEARCH AND DEVELOPMENT

Not Applicable.

### BACKGROUND

Various types of packaging for food products are well known in the art. In particular, pouches are currently used in the packaging of a wide variety of food and beverage products. Pouches for food and beverage products are frequently marketed for use by infants and children because the pouches are convenient, inexpensive, and provide ease of use. A variety of nutritional food and beverage products are available in pouches.

Many pouches contain a nutritional liquid food or beverage that may be consumed through a spout. However, many parents are interested in finding entertaining and attractive ways to encourage their child to consume more nutritional food products. For example, some children are encouraged to eat nutritional food that is presented as a frozen treat, as opposed to a liquid.

To this end, a need exists for a unique pouch that provides a consumer with a choice of different ways to consume the same nutritional product in a liquid state, or alternatively, in a frozen state.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is perspective view of a package constructed in accordance with the inventive concepts disclosed herein.

FIG. 2 is a fragmented, sectional section view taken along the line 2-2 of FIG. 1.

FIG. 3 is a cut-away, perspective view of the package of FIG. 1 shown with a cap removed for dispensing a food product in a non-frozen or liquid state.

FIG. 4 is a perspective view of the package of FIG. 1 shown with an end partially open to expose the food product in a frozen state.

FIG. 5 is a perspective view of another embodiment of a package constructed according to the inventive concepts disclosed herein.

FIG. 6 is a perspective view of another embodiment of a package constructed according to the inventive concepts disclosed herein.

FIG. 7 is a perspective view of the package of FIG. 6, wherein a portion of the package is removed to expose a food product for consuming the same in a frozen state.

### DETAILED DESCRIPTION

Before explaining at least one embodiment of the inventive concepts disclosed herein in detail, it is to be understood that the inventive concepts re not limited in their application to the details of construction and the arrangement of the components or steps or methodologies set forth in the following description or illustrated in the drawings. The inventive concepts disclosed herein are capable of other embodiments, or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof, are intended to cover a non-exclusive inclusion. For example, a process, method, article, or apparatus that comprises a list of elements is not necessarily limited to only those elements, and may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

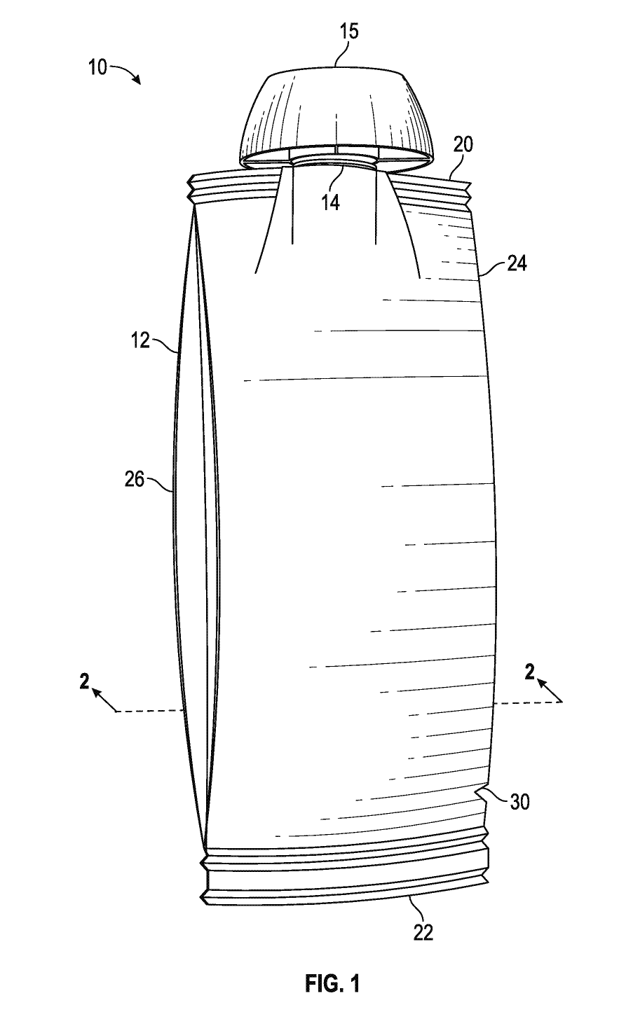

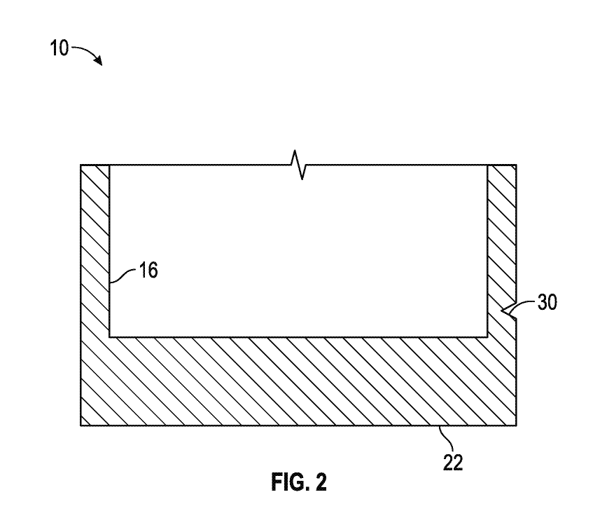

Referring now to the drawings, and in particular to FIGS. 1-4, a package 10 constructed in accordance with the inventive concepts disclosed herein is illustrated. The package 10 includes a pouch body 12, a fitment 14, and a cap 15. The pouch body 12 defines a chamber 16 in which a food product 18 may be disposed. The pouch body 12 has a top 20, a bottom 22, a front panel 24 extending between the top 20 and the bottom 22, and a back panel 26 extending between the top 20 and the bottom 22. The front panel 24 and the back panel 26 are connected at the top 20 and at the bottom 22 of the pouch body 12. In one example, but not by way of limitation, the front panel and back panels 24 and 26 may be connected to a first side gusset panel and a second side gusset panel. In another example, the front panel and back panels 24 and 26 may be connected to a bottom gusset. In yet another example, the pouch body 12 is a tube.

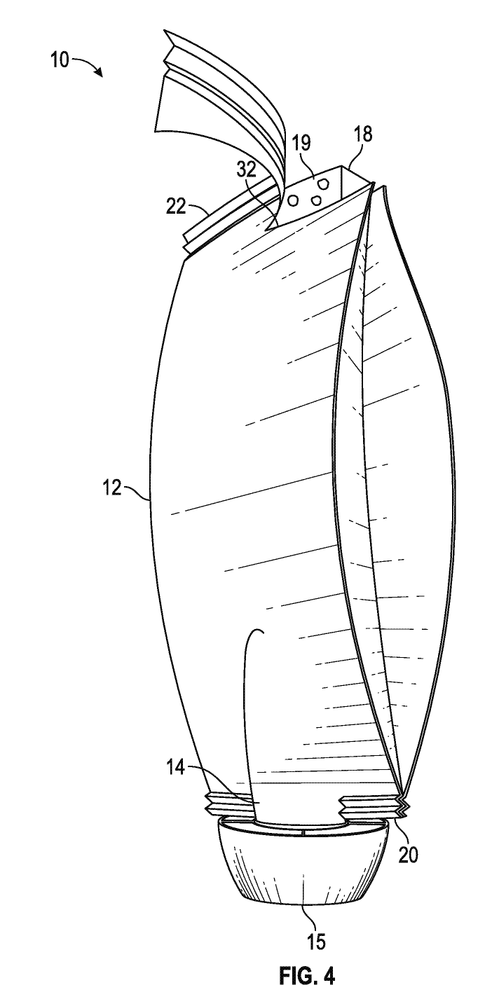

The pouch body 12 further includes a cut 30 of predetermined length positioned between the top 20 and the bottom 22 to facilitate tearing of the front and back panels 24 and 26 to create an opening 32 in the pouch body 12 for dispensing the food product 18 when the food product 18 is in a frozen state (as shown in FIG. 4). The predetermined depth of the cut 30 may be such that the cut 30 does not puncture the front and back panels 24 and 26. However, the cut 30 may be sufficiently deep so that a predetermined portion of the pouch body 12 may be torn at the cut 30 from the package 10. The cut may be made by any means known in the art, including, but not limited to, use of a laser or perforations. In one example, but not by way of limitation, the cut 30 may be a notch, and in another example, the cut 30 may be a laser score cut.

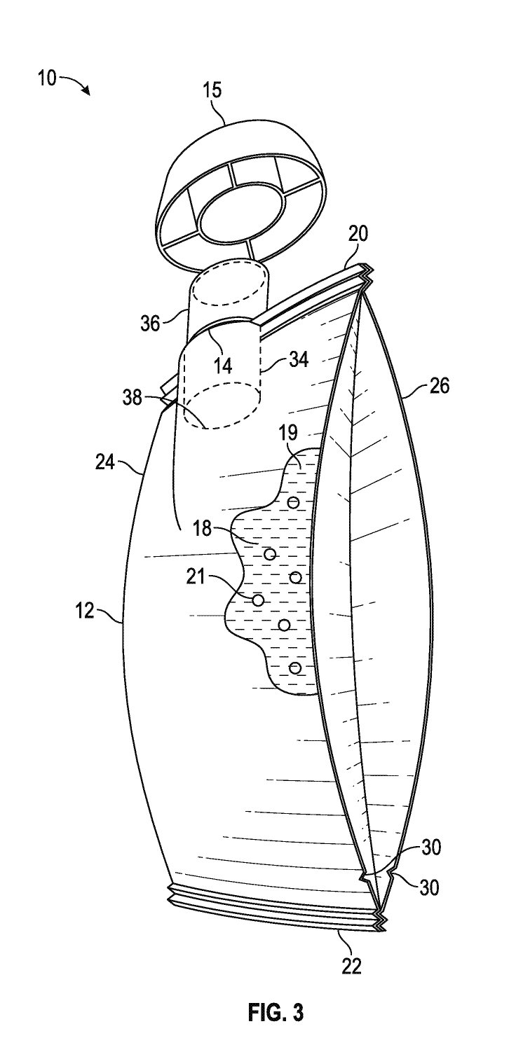

As best shown in FIG. 3, the fitment 14 is positioned between the front and back panels 24 and 26 at the top of the pouch body 12. The fitment 14 includes a base 34 and a spout 36 defining a flow passage 38 for dispensing the food product 18 from the pouch body 12 when the food product 18 is in a non-frozen or liquid state. In FIG. 3, the cap 15 is shown removed from a top portion of the spout 36 to provide access to the food product 18. The spout 36 may be cylindrical and the top portion may matingly engage with the cap 15 by a snap-fit. However, it should be appreciated that any spout 36 may be used that is capable of matingly engaging the cap 15, such as a threaded spout and cap. The fitment and spout may be made of any suitable material known in the art, such as, but not limited to, a freezable plastic.

Packages comprised of pouch bodies are well known by those having ordinary skill in the art and, therefore, will not be described in detail herein. In general, however, the pouch body 12 may be fabricated of any non-permeable, flexible material. For example, the pouch body 12 may be made of one or more flexible sheets, such as polymer sheets or foil sheets. Furthermore, the pouch body may be constructed of a transparent or an opaque material.

The package 10 may be used to contain any frozen or non-frozen, liquid food product, By way of example, the food product 18 may be a pureed food product or a beverage. designed for consumption by children such as, but not limited to, a puree, a juice, a yogurt product, a frosting, a sauce, a dip, fruit pieces, diary, cheese, or savory food products. Also, it should be appreciated that the food product may have any flavor such as, but not limited to strawberry, grape, lemon, lime, orange, white grape, vanilla, raspberry, banana, apple, chocolate, pear, yogurt, kiwi, mango, or combinations thereof.

As shown in FIGS. 3 and 4, the food product 18 may include a product body 19 and gel beads 21 suspended in the product body 19. The gel beads 21 may be comprised of a concentration of fruit, a concentration of vegetable, or a concentration of a combination of fruit and vegetable. The gel beads 21 may be nutritionally beneficially (e.g., comprised of naturally derived fiber, vitamins, or minerals) and may provide a visually appealing and entertaining feature for encouraging children to eat more fruits and vegetables. The gel beads 21 may also be developmentally appropriate for infants and toddlers, who are becoming accustomed to lumpy textures.

In use, the food product 18 may be consumed in a non-frozen or liquid state from the top 20 of the pouch body 12 by twisting or removing the cap 15 from the spout 36. A consumer may then hold and squeeze the pouch body 12 to aide in pushing the food product 18 in an upward direction towards the spout 36 and dispensing the food product 18 through the flow passage 38. The consumer may also suck on the spout 36 to pull the food product 18 from the chamber 16 and through the flow passage 38. The pouch body 12 may not tear while the food product 18 is being consumed through flow passage 38 of the spout 36.

Alternatively, the food product 18 may be consumed in a frozen state from the bottom 22 of the pouch body 12 by tearing the pouch body 12 open at the cut 30 and removing a portion of the pouch body 12 from the package 10. A consumer may then push the frozen food product 18 through the opening 32 to consume the frozen food product 18 or may remove additional portions of the pouch body 12 from the package 10 to expose more of the food product 18 for consumption. The cap 15 remains attached to the spout 36 while the food product 18 is consumed in a frozen state. Because the food product 18 may be consumed in both a frozen and a non-frozen state, the inventive concepts described herein provide incremental eating occasions and different choices of consumption for children. For example, a child may be more interested in consuming fruits and vegetables if they are presented as a frozen treat.

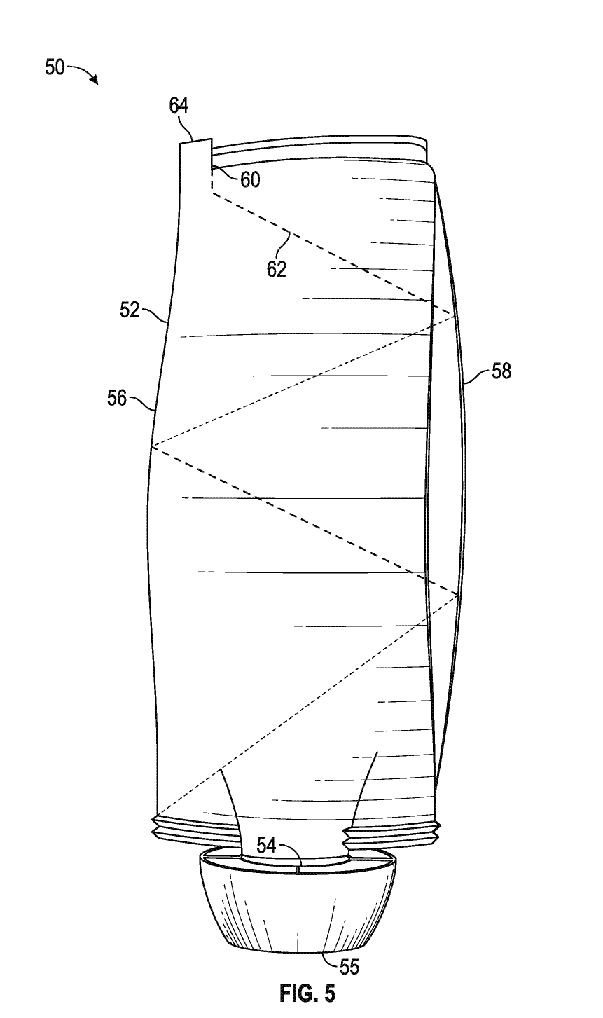

Referring now to FIG. 5, another embodiment of a package 50 constructed in accordance with the inventive concepts disclosed herein is illustrated. The package 50 includes a pouch body 52, a fitment 54, and a cap 55. The pouch body 52 includes a front panel 56 and a back panel 58. The package 50 is constructed similar to the package 10, except that the package 50 includes a cut 60 and a tear-line 62 extending spirally around the pouch body 50 and terminating in a tab 64 near the cut 60 for spirally tearing the front and back panels 56 and 58 to expose a food product in a frozen state disposed in the pouch body 52. In this way, a consumer is given a choice of how much of the food product to expose and of how much of the pouch body 52 remains for holding on to the food product. It should be appreciated that a food product in a liquid may also be dispensed from the package 50 in a similar manner as describe with reference to the package 10.

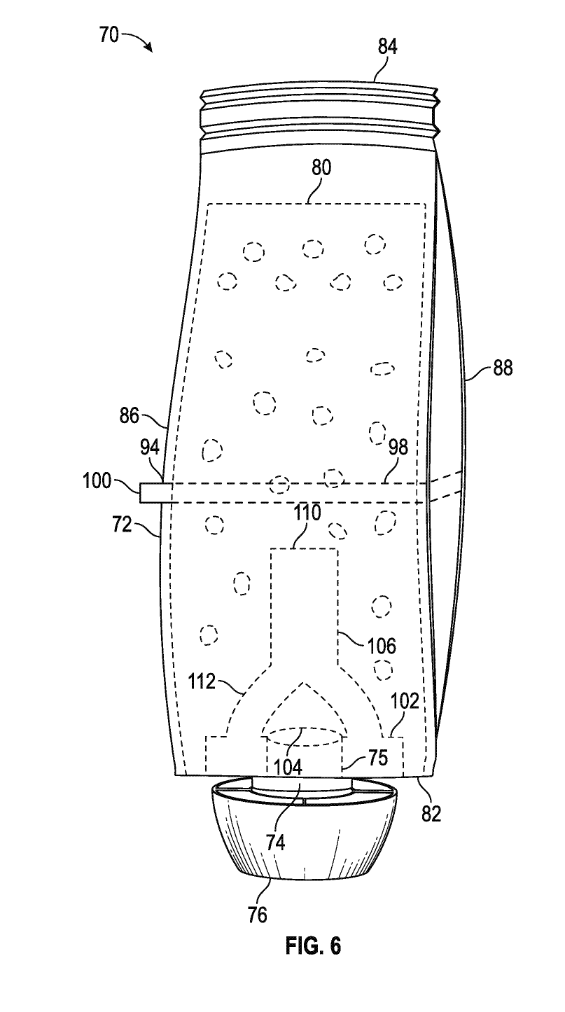

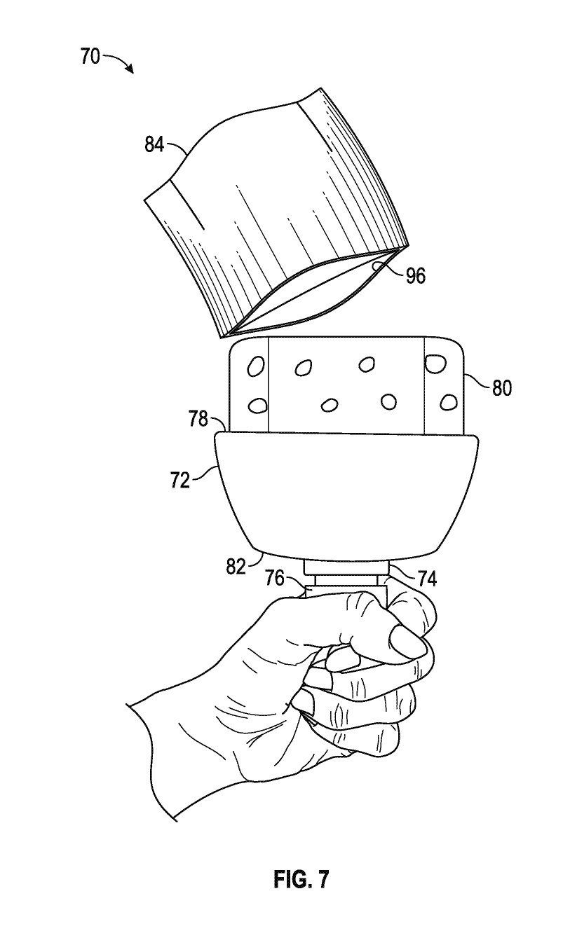

Referring now to FIGS. 6 and 7, another embodiment of a package 70 constructed in accordance with the inventive concepts disclosed herein is illustrated. Similar to packages 10 and 50, the package 70 includes a pouch body 72, a fitment 74, and a cap 76. The pouch body 72 defines a chamber 78 in which a food product 80 may be disposed. The pouch body 72 has a top 82, a bottom 84, a front panel 86 extending between the top 82 and the bottom 84, and a back panel 88 extending between the top 82 and the bottom 84. The front panel 86 and the back panel 88 are connected at the top 82 and at the bottom 84.

The pouch body 72 further includes a cut 94 of predetermined length positioned between the top 82 and the bottom 84. The pouch body 72 also includes a tear-away strip 98 extending circumferentially along the pouch body 72 and terminating in a tab 100 formed near the cut 94 for tearing the front and back panels 86 and 88 to create an opening 96 in the pouch body 72 for dispensing the food product 80 when the food product 80 is in a frozen state.

The fitment 74 is positioned between the front and back panels 86 and 88 at the top of the pouch body 72. The fitment 74 includes a base 102 and a spout 75 defining a flow passage 104 for dispensing the food product 80 from the pouch body 72 when the food product 80 is in a non-frozen or liquid state. The fitment 74 also includes a stick member 106 extending from the base 102 into the chamber 78 in a way that the food product 80 adheres to the stick member 106 when the food product 80 is in a frozen state. The stick member 106 includes a head 110 and a plurality of legs 112 extending from the base 102 in a spaced relation about the flow passage 104 and converging towards the head 110. The plurality of legs 112 may also extend between the base 102 and the head 110 in a parallel relationship.

In use, the food product 80 may be consumed in a frozen state like a freezer pop on a stick. After placing the package 70 in the freezer for an amount of time to allow the food product 80 to freeze, a consumer may use the fitment 74 and the cap 76 as a holding device while tearing the pouch body 72 open by pulling on the tab 100 and removing the tear-away trip 98. The consumer may then discard a portion of the pouch body 72 removed from the remainder of the package 70 and lick or bite the food product 80, which is adhered to the stick member 106. The stick member may be made of any suitable material known in the art, such as, but not limited to, a freezable plastic. It should be appreciated that the stick member 106 may be employed in conjunction with any one of packages 10, 50, and 70. For example, the spiral opening mechanism of the package 50 (shown in FIG. 5) may be used with the stick member 106 such that a consumer may be given a choice as to how much of the pouch body 72 remains about the food product 80.

It should also be appreciated that the food product 80 may be consumed in a liquid state, like the food product 18 described above. Because the stick member 106 is y-shaped, the food product 80 may pass through the passageway 104 as a consumer squeezes on the pouch body 72 and/or sucks on the spout 75 to move the food product 80 towards the spout 75 and through the flow passage 104 when the food product 80 is in a liquid state. Therefore each of the packages 10, 50, and 70 provide alternative and interesting ways for consuming a food product.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and/or as defined in the appended claims.

1. A package for consuming a food product, the package comprising:
a pouch body defining a chamber in which a food product may be disposed, the pouch body having a top, a bottom, and a cut of predetermined depth positioned between the top and the bottom to facilitate tearing of the pouch body to create an opening in the pouch body for dispensing the food product from the pouch body when the food product is in a frozen state; and
a fitment positioned at the top of the pouch body, the fitment having a base and a spout defining a flow passage for dispensing the food product from the pouch body when the food product is in a non-frozen state.

2. The package of claim 1, further comprising a cap removably attached to the spout of the fitment.

3. The package of claim 1, wherein the cut is a notch.

4. The package of claim 1, wherein the cut is a laser scored cut. The package of claim 1, further comprising a tear-line extending spirally around the pouch body and terminating in a tab formed near the cut for spirally tearing the pouch body.

6. The package of claim 1, further comprising a tear-away strip extending circumferentially along the pouch body and terminating in a tab formed near the cut for tearing the pouch body.

7. The package of claim 1, wherein the fitment further comprises a stick member extending from the base into the chamber in a way that the food product adheres to the stick member when the food product is in the frozen state.

8. The package of claim 7, wherein the stick member has a head and a plurality of legs extending from the base in a spaced relation about the flow passage.

9. A package, comprising:
a food product;
a pouch body defining a chamber in which the food product may be disposed, the pouch body having a top, a bottom, and a cut of predetermined depth positioned between the top and the bottom to facilitate tearing of the front and back panels to create an opening in the pouch body for dispensing the food product from the pouch body when the food product is in a frozen state; and
a fitment positioned at the top of the pouch body, the fitment having a base and a spout defining a flow passage for dispensing the food product from the pouch body when the food product is in a non-frozen state.

10. The package of claim 9, wherein the food product is a puree.

11. The package of claim 9, wherein the food product is a juice.

12. The package of claim 9. wherein the food product further comprises a product body and gel beads suspended in the product body.

13. The package of claim 10, wherein the food product further comprises a product body and gel beads suspended in the product body.

14. The package of claim 11, wherein the food product further comprises a product body and gel beads suspended in the product body.

15. The package of claim 9, wherein the food product is transparent.

16. The package claim 9, wherein the food product further comprises a product body and gel beads suspended in the product body, wherein the gel beads are comprised of a concentration of fruit.

17. The package of claim 9, wherein the food product further comprises a product body and gel beads suspended in the product body, wherein the gel beads are comprised of a concentration of vegetable.

18. The package of claim 9, wherein the food product further comprises a product body and gel beads suspended in the product body. wherein the gel beads are comprised of a concentration of vegetable and fruit.
